(19) United States
(12) Patent Application Publication
(10) Pub. No.: US 2025/0248365 A1
(43) Pub. Date: Aug. 7, 2025

(54) INTELLIGENT FEEDING METHODS AND DEVICES

(71) Applicants: Xuan TAN, Birmingham, AL (US); Hao YU, Birmingham, AL (US); Yingyu LI, Birmingham, AL (US)

(72) Inventors: Xuan TAN, Birmingham, AL (US); Hao YU, Birmingham, AL (US); Yingyu LI, Birmingham, AL (US)

(21) Appl. No.: 19/047,683

(22) Filed: Feb. 7, 2025

Related U.S. Application Data
(60) Provisional application No. 63/551,035, filed on Feb. 7, 2024.

(51) Int. Cl. A01K 5/02; G06V 20/40

(52) U.S. Cl. CPC A01K 5/0291; G06V 20/44

(57) ABSTRACT

Embodiments of the present disclosure provide an intelligent feeding method and device. The intelligent feeding method comprises obtaining a current feeding scheme of a target object, dispensing food to the target object based on the current feeding scheme, and obtaining current feeding information of the target object when dispensing food to the target object based on the current feeding scheme, determining a target feeding scheme for the target object based on the current feeding information, historical feeding data, and the current feeding scheme, and dispensing food to the target object based on the target feeding scheme.

### CROSS REFERENCE TO RELATED APPLICATIONS

The present disclosure claims priority to Provisional Patent Application No. 63/551,035, filed on Feb. 7, 2024, the entire contents of which is incorporated herein by reference.

### TECHNICAL FIELD

The present disclosure relates to the field of pet supplies, and in particular, to an intelligent feeding method and device.

### BACKGROUND

In modern society, pets have become an important part of many families, and a balanced diet during the process of raising pets is crucial for their health. Automatic pet feeders provide convenience by delivering food and water to pets at scheduled times and in specified quantities, making it easier for pet owners to care for their pets. However, different pets have varying food preferences and eating habits. Since automatic feeders follow fixed programs for dispensing food and water, they may struggle to meet the specific dietary needs of individual pets, potentially leading to health risks.

Therefore, it is desired to provide an intelligent feeding method and device, which can specifically satisfy the dietary needs of different pets and achieve personalized feeding, ensuring the health of the pets.

### SUMMARY

One embodiment of the present disclosure provides an intelligent feeding method, comprising: obtaining a current feeding scheme of a target object, dispensing food to the target object based on the current feeding scheme, and obtaining current feeding information of the target object when dispensing food to the target object based on the current feeding scheme; and determining a target feeding scheme for the target object based on the current feeding information, historical feeding data, and the current feeding scheme, and dispensing food to the target object based on the target feeding scheme.

One embodiment of the present disclosure provides an intelligent feeding device, comprising a processor and a feeder. The feeder is configured to store and dispense pet food, and the processor is configured to obtain a current feeding scheme of a target object, dispense food to the target object based on the current feeding scheme, and obtain current feeding information of the target object when dispensing food to the target object based on the current feeding scheme; and determine a target feeding scheme for the target object based on the current feeding information, historical feeding data, and the current feeding scheme, and dispense food to the target object based on the target feeding scheme.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, where:

FIG. 1 is a schematic diagram illustrating an exemplary application scenario of an intelligent feeding device according to some embodiments of the present disclosure;

FIG. 2 is a schematic diagram illustrating an exemplary structure of an intelligent feeding device according to some embodiments of the present disclosure;

FIG. 3 is a flowchart illustrating a process of an intelligent feeding method according to some embodiments of the present disclosure;

FIG. 4 is a flowchart illustrating another process of an intelligent feeding method according to some embodiments of the present disclosure;

FIG. 5 is a flowchart illustrating a process of a multi-stage intelligent feeding method according to some embodiments of the present disclosure; and

FIG. 6 is a flowchart illustrating a process for determining a feeding amount of a target object according to some embodiments of the present disclosure.

### DETAILED DESCRIPTION

In order to more clearly illustrate the technical solutions of the embodiments of the present disclosure, the following will briefly introduce the accompanying drawings to be used in the description of the embodiments. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device”, “unit” and/or “module” are used herein as a way to distinguish between different components, elements, parts, sections, or assemblies at different levels. However, the words may be replaced by other expressions if other words accomplish the same purpose.

As shown in the present disclosure and in the claims, unless the context clearly suggests an exception, the words “a”, “an”, “one” and/or “the” do not refer specifically to the singular, but may also include the plural. Generally, the terms “including” and “comprising” suggest only the inclusion of clearly identified steps and elements that do not constitute an exclusive list, and the method or device may also include other steps or elements.

Flowcharts are used in the present disclosure to illustrate operations performed by a system in accordance with embodiments of the present disclosure. It should be appreciated that the preceding or following operations are not necessarily performed in an exact sequence. Instead, steps can be processed in reverse order or simultaneously. Also, it is possible to add other operations to these processes or remove a step or step from them.

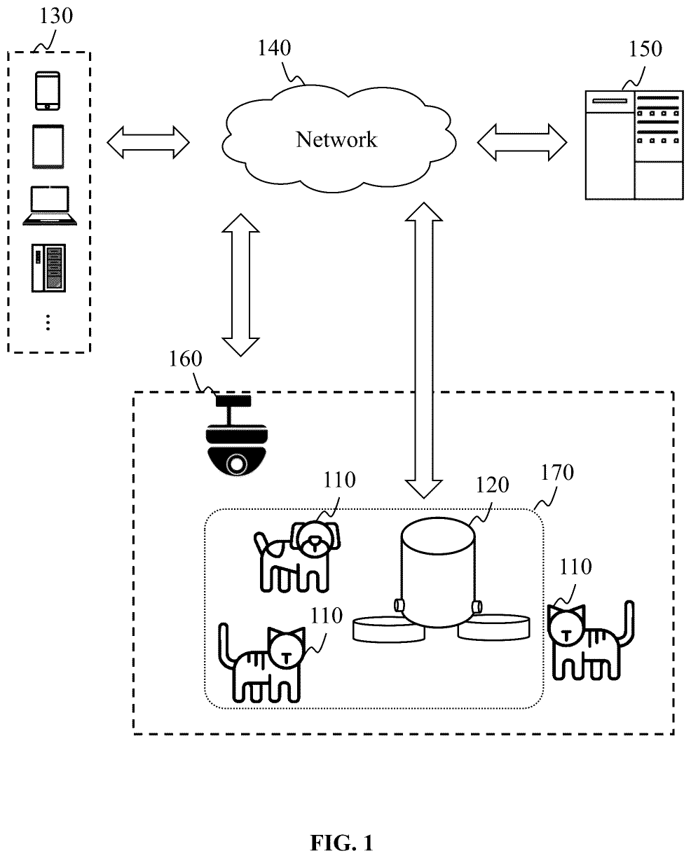

FIG. 1 is a schematic diagram illustrating an exemplary application scenario of an intelligent feeding device according to some embodiments of the present disclosure.

As shown in FIG. 1, an application scenario 100 of the intelligent feeding device includes a feeding object 110, a feeder 120, a user terminal 130, a network 140, and a processor 150. In some embodiments, the processor 150 obtains a current feeding scheme of the feeding object 110, controls the feeder 120 to dispense food to the feeding object 110 based on the current feeding scheme through the network 140, and obtains initial feeding information of the feeding object 110 when controlling the feeder 120 to dispense food to the feeding object 110 based on the current feeding scheme through the network 140, determines a target feeding scheme for the feeding object 110 based on the initial feeding information, historical feeding data, and the current feeding scheme, and controls the feeder 120 to dispense food to the feeding object 110 based on the target feeding scheme through the network 140. More description of the above embodiments can be found below in the present disclosure.

The feeding object 110 refers to a pet fed by the feeder 120. For example, the feeding object 110 includes, but is not limited to, various types of cats, dogs, chickens, ducks, and pigs fed by the feeder 120. The feeder 120 may feed one or more feeding objects 110. For a feeding time period corresponding to each feeding target 110, the processor 150 may determine the feeding object 110 as a target object, and determine a feeding object located within a feeding region 170 corresponding to the target object 110 as an object awaiting feeding. The object awaiting feeding may or may not include the target object. For example, the feeder 120 illustrated in FIG. 1 feeds three feeding objects 110, and a feeding region corresponding to a certain target object is the feeding region 170. The processor 150 may determine two of the three feeding objects 110 located in the feeding region 170 during a feeding time period corresponding to the target object as objects awaiting feeding, and determine another feeding object 110 located outside of the feeding region 170 as an object not awaiting feeding.

The feeder 120 refers to a device for feeding the target object. The feeder 120 may be used to store and dispense pet food. The feeder 120 may be equipped with a controllable rotary valve for feeding amount. The rotary valve can control the amount of food released and the timing based on the feeding scheme (such as a current feeding scheme, a target feeding scheme, etc.) of the target object.

The user terminal 130 refers to one or more terminal devices or software used by a user. The user refers to a user of the feeder 120. The user may query a feeding situation and a feeding scheme of each feeding object 110 through the user terminal 130. The user may also upload object information (e.g., first object information, second object information, etc.) of each feeding object 110 through the user terminal 130. The user may also upload a feeding requirement of each feeding object 110 through the user terminal 130. More about the object information, and the feeding requirement can be found in the relevant descriptions below in the present disclosure. The user terminal 130 may be used by one or more users, and the one or more users may include a user who is directly using a service, as well as other related users. The user terminal 130 may be one of a mobile device, a tablet computer, a laptop computer, a desktop computer, and other devices with input and/or output capabilities, or any combination thereof.

The network 140 may connect a plurality of components of the application scenario 100 of the intelligent feeding device and/or connect the application scenario 100 of the intelligent feeding device with an external resource. The network 140 may enable communication between the plurality of components of the application scenario 100 of the intelligent feeding device, and with other portions of the application scenario 100 of the intelligent feeding device outside of the application scenario 100, to facilitate data and/or exchange of information. The network 140 may be any one or more of a wired network or a wireless network. For example, the network 140 includes a cable network, a fiber optic network, a telecommunication network, the Internet, a local area network, a wide area network, a wireless local area network, a Bluetooth network, a near-field communication, an in-device bus, an in-device line, cable connections, etc. or any combination thereof. A network connection between various portions may be made in one of the above ways or in multiple ways.

The processor 150 may process data and/or information obtained from other devices or components of the application scenario 100 of the intelligent feeding device. The processor 150 may execute program instructions and control other components of the application scenario 100 of the intelligent feeding device (e.g., the feeder 120) based on such data, information, and/or processing results to execute one or more functions described in the present disclosure. For example, the processor 150 obtains the current feeding scheme of the target object, dispenses food to the target object based on the current feeding scheme, and obtains the initial feeding information of the target object when dispensing food to the target object based on the current feeding scheme of the target object, determines the target feeding scheme for the target object based on the initial feeding information, the historical feeding data, and the current feeding scheme, and dispenses food to the target object based on the target feeding scheme. More description of the above example can be found below in the present disclosure. In some embodiments, the processor 150 includes one or more sub-processing devices (e.g., a single-core processing device or a multi-core processing device). For example, the processor 150 includes a central processor, a dedicated integrated circuit, a dedicated instruction processor, a graphics processor, a physical processor, a digital signal processor, a controller, a microcontroller unit, a microprocessor, etc., or any combination of the above.

It should be noted that the application scenario 100 of the intelligent feeding device is provided for illustrative purposes only and is not intended to limit the scope of the present disclosure. For a person of ordinary skill in the art, a variety of modifications or variations may be made in accordance with the description of the present disclosure.

In some embodiments, the application scenario 100 of the intelligent feeding device further includes an image acquisition device 160. The image acquisition device 160 is configured to obtain an image (e.g., one or more of a target image, a feeding image, and a food bowl image) by capturing an image of the feeding region of the target object. For example, the image acquisition device 160 obtains a target image by capturing a picture of the feeding region 170 during the feeding time period corresponding to the target object. As another example, the target feeding scheme also includes a plurality of sub-feeding schemes for stages, and after the feeder 120 has finished dispensing food based on a sub-feeding scheme for each stage, the image acquisition device 160 further obtains a feeding image of a feeding region. As another example, after the feeder 120 has finished dispensing food to the target object based on a feeding scheme, the image acquisition device 160 further obtains a food bowl image of a food bowl used by the target object. More about the target image, the feeding image, and the food bowl image can be found in the relevant description below in the present disclosure. The image acquisition device 160 may be realized by one or more cameras arranged on the feeder 120, or by one or more home cameras. An image obtained by the image acquisition device 160 may be transmitted to the processor 150 through the network 140.

In some embodiments, the application scenario 100 of the intelligent feeding device further includes an audio player (not shown in FIG. 1). The audio player may play a reminder audio corresponding to the target object when dispensing food to the target object based on the target feeding scheme.

In some embodiments, the application scenario 100 of the intelligent feeding device further includes a lighting apparatus (not shown in FIG. 1). The lighting apparatus may turn on a reminder light corresponding to the target object when dispensing food to the target object based on the target feeding scheme.

In some embodiments, a plurality of components of the application scenario 100 of the intelligent feeding device is integrated into a single device, e.g., the processor 150 and/or the image acquisition device 160 of the application scenario 100 of the intelligent feeding device are integrated into the feeder 120. For example, the application scenario 100 of the intelligent feeding device is implemented on other devices to achieve similar or different functionality. However, each of the foregoing variations and modifications will not depart from the scope of the present disclosure.

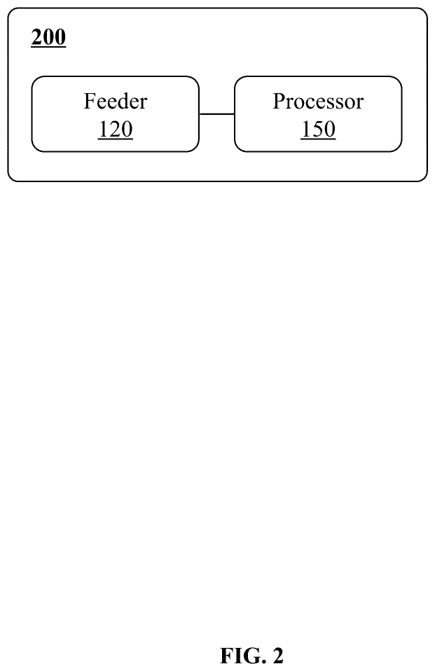

FIG. 2 is a schematic diagram illustrating an exemplary structure of an intelligent feeding device according to some embodiments of the present disclosure.

An intelligent feeding device 200 can be used to automate personalized feeding of a feeding object, reducing manual intervention and facilitating daily feeding of pets.

As shown in FIG. 2, the intelligent feeding device 200 includes the feeder 120 and the processor 150.

The feeder 120 may be configured to store and dispense pet food, and more about the feeder 120 can be found in FIG. 1 and the related description thereof. In some embodiments, the feeder 120 includes one or more dispensing ports, and each of the one or more dispensing ports corresponds to a food bowl of a pet, thereby realizing that a single feeder 120 can feed a plurality of pets, which reduces costs while also making it easier for users to switch food and perform cleaning tasks.

The processor 150 may be configured to obtain a current feeding scheme of a target object, dispense food to the target object based on the current feeding scheme, and obtain initial feeding information of the target object when dispensing food to the target object based on the current feeding scheme, determine a target feeding scheme for the target object based on the initial feeding information, historical feeding data, and the current feeding scheme, and dispense food to the target object based on the target feeding scheme.

In some embodiments, the processor 150 is further configured to determine the current feeding scheme of the target object based on first object information of the target object and the initial feeding scheme using a same-type feeding model.

In some embodiments, the processor 150 is further configured to obtain a feeding target of the target object, determine the target feeding scheme for the target object based on the feeding target, the initial feeding information, the historical feeding data, and the current feeding scheme.

In some embodiments, the processor 150 is further configured to obtain the target feeding scheme for the target object by adjusting the current feeding scheme through a scheme adjustment strategy based on the feeding target, the current feeding information, and the historical feeding data.

In some embodiments, the processor 150 is further configured to obtain a target feeding model of the target object based on the initial feeding information, the historical feeding data, and the current feeding scheme, and determine the target feeding scheme for the target object based on second object information, the current feeding scheme, and the feeding target using the target feeding model.

In some embodiments, the processor 150 is further configured to determine a feeding time period of the target object based on the target feeding scheme, obtain a target image of a feeding region corresponding to the target object during the feeding time period, determine an object awaiting feeding in the feeding region based on the target image; and in response to determining the object awaiting feeding including the target object, dispense food to the target object based on the target feeding scheme.

In some embodiments, the processor 150 is further configured to play a reminder audio corresponding to the target object and/or turn on a reminder light corresponding to the target object when dispensing food to the target object based on the target feeding scheme.

In some embodiments, the target feeding scheme includes a plurality of sub-feeding schemes for stages, and the processor 150 is further configured to dispense food to the target object stage by stage based on the plurality of sub-feeding schemes for stages. In some embodiments, the processor 150 is further configured to, for a sub-feeding scheme for each stage, dispense food based on the sub-feeding scheme for each stage, obtain a feeding image of a feeding region, determine an eating object in the feeding region based on the feeding image; and stop dispensing food to the target object based on a sub-feeding scheme for a next stage when the eating object includes objects other than the target object.

The intelligent feeding device 200 may also include other components. For example, the intelligent feeding device 200 includes a memory (not shown in FIG. 2), and the memory is configured to store data related to the intelligent feeding device 200 (e.g., the initial feeding scheme, the current feeding scheme, the target feeding scheme, etc.). As another example, the intelligent feeding device 200 also includes the image acquisition device 160, and more about the image acquisition device 160 can be found in FIG. 1 and the related description thereof. In some embodiments, the processor 150 also acquires at least one of a target image, a feeding image, or a food bowl image through a home camera provided outside the intelligent feeding device 200. By obtaining related images through one or more home cameras provided outside the intelligent feeding device 200, there is no need for the user to additionally purchase other camera devices, which can reduce the user's cost and reduce the waste of resources. In addition, the home camera can have a larger field of view compared to camera devices arranged in the intelligent feeding device 200, which can obtain related images of different feeding regions. As another example, the intelligent feeding device 200 further includes a lighting apparatus (not shown in FIG. 2), and the lighting apparatus is configured to turn on a reminder light corresponding to the target object when dispensing food to the target object based on the target feeding scheme. This setup can guide the target object to understand a reminder light during feeding, enabling targeted feeding and preventing food-snatching behavior. As another example, the intelligent feeding device 200 further includes an audio player (not shown in FIG. 2), and the audio player is configured to play a reminder audio corresponding to the target object when dispensing food to the target object based on the target feeding scheme. This setup can guide the target object to understand a reminder audio during feeding, enabling targeted feeding and preventing food-snatching behavior.

It should be understood that the intelligent feeding device 200 and its components shown in FIG. 2 may be realized utilizing a variety of means. It should be noted that the above description of the intelligent feeding device 200 and its components is for descriptive convenience only, and it does not limit the present disclosure to the scope of the embodiments cited. It is to be understood that for a person skilled in the art, with an understanding of the principle of the device, it is possible to arbitrarily combine individual components or form sub-devices to be connected to other components without departing from this principle. Deformations such as these are within the scope of protection of the present disclosure.

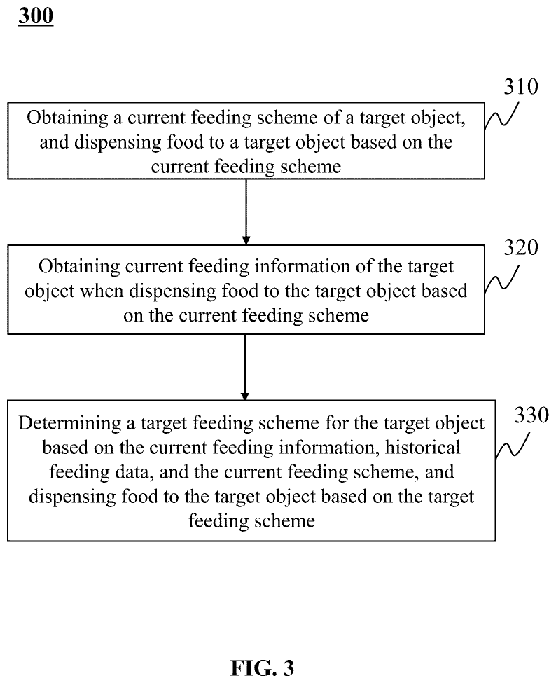

FIG. 3 is a flowchart illustrating a process of an intelligent feeding method according to some embodiments of the present disclosure.

In some embodiments, a process 300 may be performed by a processor of an intelligent feeding device (e.g., the processor 150 of the intelligent feeding device 200 shown in FIG. 2). As shown in FIG. 3, the process 300 may include following steps:

Step 310, obtaining a current feeding scheme of a target object, and dispensing food to the target object based on the current feeding scheme.

The current feeding scheme refers to a feeding scheme currently performed on the target object. A feeding scheme refers to a feeding scheme performed on a feeding object. One or more feeding schemes may be stored in the intelligent feeding device, and each of the one or more feeding schemes may correspond to a feeding object. Each feeding object may have a different feeding scheme, and each feeding object may correspond to a plurality of feeding schemes. For example, a cat may have three different feeding schemes corresponding to three different time periods, and the three feeding schemes may be the same or different.

For each feeding scheme, a feeding object corresponding to the feeding scheme is a target object. The intelligent feeding method based on the target object may be described later in the present disclosure.

The feeding scheme may at least include a feeding time period and a food-dispensing amount for a target object. The food-dispensing amount refers to a weight of pet food that a feeder dispenses during the feeding time period. The feeding time period refers to a time period set for the target object's feeding. During the feeding time period, the feeder may dispense pet food corresponding to a specified amount of weight to the target object. For example, the current feeding scheme includes at least a current feeding time period during which the target object is currently feeding and a current food-dispensing amount. The feeding scheme may also include other relevant parameters. For example, the feeding scheme may also include a food-dispensing speed.

The current feeding scheme may be obtained in a number of manners. For example, the current feeding scheme may be obtained through user input. As another example, the processor directly determines the initial feeding scheme as the current feeding scheme. More content about the initial feeding scheme can be referred to the descriptions below.

In some embodiments, the processor may determine a target feeding scheme for the target object determined by a previous execution of the process 300 as a current feeding scheme for a current execution of the process 300, which enables continuous iteration, updating, and adjustment of the feeding scheme of the target object, ensuring that the feeding scheme satisfies current needs and preferences of the target object, providing the necessary nutrients, and safeguarding its health.

In some embodiments, the processor further determines the current feeding scheme of the target object based on first object information of the target object.

The first object information refers to object information of the target object before food is dispensed on the target object based on the current feeding scheme. The object information refers to information reflecting a physiological condition of the target object. For example, the object information includes, but is not limited to, one or more of a breed, an age, a gender, a weight, a glucose value, a heart rate, an activity level, or the like of the target object. The first object information may be obtained in a variety of ways. For example, a user inputs the first object information through a user terminal (e.g., a user terminal shown in FIG. 1), and the processor obtains the first object information input by the user. As another example, the processor obtains an image including the target object through the image acquisition device 160 and performs image analysis on the image to obtain the first object information. The first object information may also be obtained through an Internet of Things (IoT) device. For example, the target object wears a wearable device, which can provide data such as the target object's heart rate and activity level. Furthermore, the target object may also wear a continuous glucose monitoring device, which can provide real-time data on glucose fluctuations.

When the processor first executes the process 300, the processor may determine the current feeding scheme of the target object based on the first object information of the target object.

In some embodiments, the processor determines the current feeding scheme of the target object based on the first object information of the target object through a preset feeding rule.

In some embodiments, the processor further determines the current feeding scheme of the target object based on the first object information of the target object and an initial feeding scheme using a same-type feeding model.

The initial feeding scheme refers to a feeding scheme of the target object before the iteration, update, and adjustment of the feeding scheme of the target object begins based on the execution of the process 300. For example, before executing the process 300, the processor determines the current feeding scheme of the target object based on the first object information and the initial feeding scheme. The processor optimizes an existing feeding scheme of the target object to maintain continuity in a feeding scheme of the target object, such as keeping the types of food unchanged, in order to minimize the impact of food substitutions on the target object.

The processor may input the first object information and the initial feeding scheme into the same-type feeding model, and designate the output of the same-type feeding model as the target feeding scheme for the target object. The same-type feeding model may be a deep learning model or any other machine learning model that can implement its functionality.

The same-type feeding model may be obtained by training a first training sample with a first label. The first training sample may be sample first object information and a sample initial feeding scheme of a similar object corresponding to the target object, and the first label may be a sample current feeding scheme of the similar object.

The sample first object information refers to object information of the similar object before food is dispensed to the similar object based on the sample current feeding scheme.

The similar object may be an object that is physiologically similar to the target object. The processor may obtain sample first object information of a plurality of feeding objects and construct a feature vector based on the sample first object information and the first object information, determine sample first object information whose vector distance from a feature vector of the first object information is less than a preset distance threshold, and determine a feeding object corresponding to the sample first object information as the similar object of the target object.

For each similar object, the processor may obtain, based on sample first object information and sample second object information corresponding to the similar object, determine whether the sample first object information and the sample second object information corresponding to the similar object satisfy a preset feeding condition. In response to determining the sample first object information and the sample second object information corresponding to the similar object satisfying the preset feeding condition, an adjusted feeding scheme of the similar object is determined as the sample current feeding scheme, and a feeding scheme of the similar object before adjustment is determined as the sample initial feeding scheme. The sample second object information may be object information of the similar object after the food is dispensed to the similar object based on the adjusted feeding scheme. The preset feeding condition may represent a reasonable condition for adjusting a feeding scheme based on the similar object. For example, the preset feeding condition includes a weight change value of the similar object in the second sample object information, compared to a weight of the similar object in the first sample object information, being within a preset weight range (e.g., 0˜+50 g). As another example, the preset feeding condition may include a glucose stability of the similar object in the second sample object information, compared to a glucose stability of the similar object in the first sample object information, being within a preset stability range.

In some embodiments, an input of the same-type feeding model further includes a feeding target of the target object. Correspondingly, the preset feeding condition may be determined based on the feeding target of the target object. For example, the preset feeding condition includes the weight change value of the similar object in the second sample object information compared to the weight of the similar object in the first sample object information satisfying a target weight change value in the feeding target. As another example, the preset feeding condition further includes the glucose stability of the similar object in the second sample object information compared to the glucose stability of the similar object in the first sample object information satisfying a target glucose stability in the feeding target. Correspondingly, the first label further includes a sample feeding target of the similar object when training the same-type feeding model. More about the feeding target can be found in the relevant description below in the present disclosure.

In some embodiments of the present disclosure, based on the first object information of the target object and the initial feeding scheme by using the same-type feeding model, the current feeding scheme of the target object can be quickly and accurately determined, ensuring reasonable feeding for the target object and laying a solid foundation for the iteration of the feeding scheme.

The processor may control the feeder (e.g., the feeder 120 shown in FIG. 2) to dispense pet food corresponding to a food-dispensing amount in the current feeding scheme to the target object during a feeding time period in the current feeding scheme.

Step 320, obtaining current feeding information of the target object when dispensing food to the target object based on the current feeding scheme.

The current feeding information refers to feedback information of the target object after the food is dispensed to the target object based on the current feeding scheme. For example, the current feeding information includes an amount of food consumed by the target object, a fastest feeding speed, an average feeding speed, a total feeding time, a single sustained feeding time, whether the target object is picky in eating, or the like. As another example, the current feeding information further includes a degree of satiety of the target object after feeding, a degree of preference of the target object for corresponding pet food, and whether the target object burps, vomits, suffers from indigestion, or the like. As another example, the current feeding information further includes a glucose stability, a weight change value, an actual calorie intake, or the like of the target object after feeding.

The current feeding information may be obtained in a variety of ways. For example, the current feeding information is obtained through user input. As another example, after the food is dispensed to the target object based on the current feeding scheme, the processor continually obtains a plurality of images including the target object through the image acquisition device and performs image analysis on the plurality of images to determine the current feeding information. As another example, a food bowl image of a food bowl used by the target object is obtained after the food is dispensed to the target object based on a feeding scheme, and the processor continually obtains a plurality of images including the target object through the image acquisition device and performs image analysis on the food bowl image to determine an amount of food consumed in current feeding information.

Step 330, determining a target feeding scheme for the target object based on the current feeding information, historical feeding data, and the current feeding scheme, and dispensing food to the target object based on the target feeding scheme.

The historical feeding data may be data related to previous feeding of the target object. The historical feeding data may include a historical feeding scheme and historical feeding data. The historical feeding scheme may be a previous feeding scheme performed on the target object, and the historical feeding data may be feedback information of the target object after food is dispensed to the target object based on each historical feeding scheme. Each time the processor executes the process 300, the processor may store obtained data (e.g., the current feeding information) or determined data (e.g., the target feeding scheme) in the memory, and the processor may access data stored in the memory when needed, e.g., the processor may access the historical feeding data of the target object in the memory.

The target feeding scheme refers to a feeding scheme performed on the target object next time. The target feeding scheme may at least include a feeding time period and a food-dispensing amount for a next feeding of the target object. The target feeding scheme may also include other relevant parameters. For example, the target feeding scheme further includes a food-dispensing speed for the next feeding of the intelligent feeding device.

In some embodiments, the processor performs modeling or employs various data analysis algorithms, such as regression analysis, discriminant analysis, etc., to analyze and process the current feeding information, the historical feeding data, and the current feeding scheme to determine the target feeding scheme for the target object.

The processor may analyze the historical feeding data to construct a feeding database of the target object. The feeding database may include, but not limited to, a preference for various pet foods of the target object, a correspondence between a digestion time of different food components and a pet's sense of fullness, a glycemic index, a metabolic rate of the target object, a food component that may cause the target object's glucose to increase, allergies, vomiting, or diarrhea, a feeding time preference of the target object (e.g., a specific feeding time period), a food texture preference (e.g., dry food or wet food), etc. The feeding database is dynamically updated based on the current feeding information and the current feeding scheme, and then the current feeding scheme is optimized based on the updated feeding database to obtain the target feeding scheme. For example, the processor determines, based on the updated feeding database, a digestion time of the target object after a current feeding, and thus determines a feeding time period for a next feeding in the target feeding scheme. As another example, the processor determines, based on the updated feeding database, that the target object is currently feeding too fast during a current feeding, and thus determines a food-dispensing speed for a next feeding of the intelligent feeding device in the target feeding scheme.

In some embodiments, the processor obtains the feeding target of the target object and determines the target feeding scheme for the target object based on the feeding target, the current feeding information, the historical feeding data, and the current feeding scheme.

The feeding target may be a target of the target object during a next feeding. In some embodiments, the feeding target includes at least one of a target glucose stability, a target weight change value, or a target calorie intake of the target object.

The target glucose stability refers to the stability of the target object's glucose value after a next feeding, compared to a current glucose value. The target glucose stability may be represented by a score (e.g., 1 to 10 points), with higher scores indicating greater glucose stability of the target object. The target glucose stability may be related to a glucose value and/or glucose change value. The processor, based on a preset glucose correlation, may determine the glucose of the target object after a next feeding based on the target glucose stability and the current glucose value.

The target weight change value refers to a change value of the weight of the target object after the next feeding compared to a current weight. The target weight change value may be represented by a specific weight value. It can be understood that the target weight change value may be either positive (e.g., +10 g) or negative (e.g., −10 g). When the target weight change value is positive, it indicates that the target object needs to gain weight; when the target weight change value is negative, it indicates that the target object needs to lose weight.

The target calorie intake refers to the amount of calorie the target object may consume during the next feeding. The target calorie intake may be represented by a specific calorie value. For example, the target calorie intake may be 60 kcal.

In some embodiments, the feeding target further includes other data of the target object during the next feeding. For example, the feeding target may also include a total amount of food consumed by the target object during the next feeding. As another example, the feeding target further includes that the target object does not vomit, burp, suffer from indigestion, etc., during the next feeding.

The feeding target may be obtained in a variety of ways. For example, the feeding target is obtained through user input. As another example, the processor analyzes and processes the current feeding information and the historical feeding data of the target object to determine the feeding target. For example, after analyzing and processing the current feeding information and the historical feeding data of the target object, the processor determines that the current glucose value of the target object is too high and that glycemic control is needed, which further determines a glucose stability in the feeding target. As another example, the processor further determines the feeding target by integrating data from other sources. For example, the processor analyzes the activity level and exercise intensity of the target object through an image acquisition device, and determines the target calorie intake of the target object based on the activity level and exercise intensity.

In some embodiments of the present disclosure, by setting the feeding target of the target object, a target feeding scheme that is more in line with a health condition of the target object can be obtained, which realizes personalized feeding for the target object. For example, when the target object suffers from diabetes, the target feeding scheme facilitates maintaining a glucose level of the target object.

In some embodiments, the process obtains the target feeding scheme by adjusting the current feeding scheme through a scheme adjustment strategy based on the feeding target, the current feeding information, and the historical feeding data. The scheme adjustment strategy refers to a strategy used to adjust the current feeding scheme. The scheme adjustment strategy may be preset.

In some embodiments, the scheme adjustment strategy is obtained through optimization iterations. During the optimization iteration process, the scheme adjustment strategy may include a to-be-analyzed scheme adjustment strategy and/or a target scheme adjustment strategy. Specifically, the processor determines a plurality of similar objects of the target object, and feeding targets of the similar objects are the same as or similar to that of the target object (e.g., all feeding targets are related to weight loss). More details about the similar object can be found in the relevant descriptions above in the present disclosure. The processor designates the target object and the similar object of the target object as to-be-analyzed objects, and then groups a plurality of to-be-analyzed objects. For each group, the processor adjusts a current feeding scheme corresponding to objects to-be-analyzed in the group based on a feeding target, current feeding information, and historical feeding data of each object to-be-analyzed in the group through a to-be-analyzed scheme adjustment strategy to obtain a feeding scheme of the objects to-be-analyzed in the group (e.g., the target feeding scheme for the target object). Each group of to-be-analyzed objects corresponds to a different to-be-analyzed scheme adjustment strategy. After feeding each object to-be-analyzed in the group based on the feeding scheme, the processor obtains object information of to-be-analyzed objects in each group and analyzes and processes the object information to determine a group whose feeding result best aligns with the feeding target. For example, the processor determines a group whose weight change value is closest to a target weight change value in the feeding target, and the processor then determines the to-be-analyzed scheme adjustment strategy corresponding to the group as the target scheme adjustment strategy, and then processes the plurality of to-be-analyzed objects based on the target scheme adjustment strategy.

It is worth noting that, in order to minimize the impact of confounding variables and ensure the comparability of different to-be-analyzed scheme adjustment strategies, the environment of each group of to-be-analyzed objects (such as temperature, humidity, and feeding time) should be as similar as possible. The types of food in feeding schemes of each group of to-be-analyzed objects should be as consistent as possible, and the frequency of monitoring the object information (such as the fixed number of glucose tests per day) should be as consistent as possible.

In some embodiments, the processor further adjusts the target scheme adjustment strategy (e.g., by modifying a determination manner for feeding frequency, food composition, time schedule, etc., within the target scheme adjustment strategy) to obtain a plurality of new to-be-analyzed scheme adjustment strategies. Based on new to-be-analyzed scheme adjustment strategies, the processor can reanalyze and process the plurality of to-be-analyzed objects, continuously iterating to determine a new target scheme adjustment strategy. When the processor first executes the scheme adjustment strategy for iteration, the to-be-analyzed scheme adjustment strategy may be preset.

Some embodiments of the present disclosure optimize the scheme adjustment strategy corresponding to the target object through the manner described above, achieving a data-driven optimization loop, which allows for identifying the currently most suitable scheme adjustment strategy for the target object and continuously optimizing the target feeding scheme corresponding to the target object.

In some embodiments, the processor determines the updated feeding database of the target object based on the current feeding information, the historical feeding data, and the current feeding scheme, and obtains the target feeding scheme by optimizing the current feeding scheme based on the feeding target and the updated feeding database.

In some embodiments, the processor obtains a target feeding model of the target object based on the first object information of the target object, the current feeding information, the historical feeding data, and the current feeding scheme, and determines the target feeding scheme for the target object based on second object information of the target object, the current feeding scheme, and the feeding target using the target feeding model.

The second object information refers to object information of the target object after the food is dispensed to the target object based on the current feeding scheme. The specific content of the second object information and a manner for obtaining the second object information may be referred to the first object information.

The target feeding model refers to a machine learning model that matches a current feeding situation of the target object. The target feeding model may be a deep learning model or any other machine learning model that can realize its function. Inputs to the target feeding model may include the second object information, the current feeding scheme, and the feeding target, and an output of the target feeding model may include the target feeding scheme.

The target feeding model may be obtained by training a second training sample with a second label.

In some embodiments, the processor designates object information of the target object at each stage (e.g., object information of a current stage, i.e., the first object information), feeding result of a next stage corresponding to the current stage, and a feeding scheme of the current stage as a second training sample, and designates a feeding scheme of the next stage corresponding to the current stage as a second label, and the target feeding model is directly obtained by training based on the second training sample with the second label. The processor may obtain historical object information of the target object and determine the object information of the target object at each stage based on the historical object information and the first object information. The historical object information may be object information of the target object before and after each feeding, and the historical object information may be obtained from the memory. The feeding scheme of the target object at each stage may be determined based on the current feeding scheme of the target object and the historical feeding scheme. The feeding result of the target object at each stage may be determined based on the current feeding information of the target object and the historical feeding data. For example, when the current feeding information includes the glycemic stability, the weight change value, and an actual calorie intake of the target object after feeding, the process determines a feeding result of the target object at each stage based on the current feeding information and the historical feeding data of the target object. As another example, when the current feeding information dose not include the glycemic stability, the weight change value, and the actual calorie intake of the target object after feeding, the processor determines the glycemic stability, the weight change value, and the calorie intake of the target object after feeding by analyzing the current feeding information and the historical feeding data of the target object.

In some embodiments, the processor further iteratively updates the target feeding model, making it more aligned with the current feeding situation of the target object, enhancing the robustness and generalization ability of the target feeding model, and reducing the computational load required to directly train the target feeding model, thereby lowering resource consumption.

Specifically, the processor may obtain an initial feeding model of the target object, and the initial feeding model is a machine learning model that conforms to a feeding situation of the last feeding of the target object. The processor may determine a target feeding model obtained last time as an initial feeding model for this time. When the processor iteratively updates the target feeding model for a first time, the processor may determine a same-type feeding model as the initial feeding model. The processor may determine the first object information and the current feeding information as the second training sample, determine the current feeding scheme as the second label, and iteratively update the initial feeding model based on the second training sample with the second label to obtain the target feeding model.

After determining the target feeding scheme, the processor may control the intelligent feeding device to dispense food to the target object based on the target feeding scheme.

In some embodiments of the present disclosure, through the process 300, more accurate intelligent feeding for the target object can be achieved, which specifically satisfies the dietary and health needs of the target object, achieving personalized feeding, and ensuring the health of the target object. For example, the processor can ensure the target glucose stability of the target object by adjusting a feeding speed and feeding frequency in the target feeding scheme, enabling the target object awaiting feeding with small meals each time while more frequently. The processor may continually execute the process 300 to obtain a target feeding scheme that best satisfies the dietary needs and the health needs of the target object.

In some embodiments, the processor determines a health management scheme for the target object based on the target feeding scheme for the target object. The health management scheme refers to a health-related scheme for the target object. For example, the health management scheme includes, but is not limited to, an amount of exercise, an amount of water consumed, a timing of water consumed, an amount of insulin dosage, a medication feeding time, a proportion of nutrient intake, or the like of the target object.

The processor may determine the health management scheme for the target object based on the target feeding scheme for the target object through a preset health management rule. For example, the health management rule may include feeding medication to the target object two hours after a meal. The processor may determine a medication feeding time in the health management scheme for the target object based on the feeding time period in the target feeding scheme for the target object through the preset health management rule. The health management rule may also be related to other devices, such as a water dispenser corresponding to the target object. For example, the health management rule includes a restriction where the target object cannot drink water within 30 minutes after a meal to prevent vomiting.

Accordingly, the processor can control the water dispenser corresponding to the target object to stop dispensing water to the target object within 30 minutes after a meal. Further, the processor may also send the health management scheme to the user terminal (e.g., the user terminal 130 shown in FIG. 1) to facilitate the health management of the target object.

In some embodiments of the present disclosure, the health management scheme for the target object is determined based on the target feeding scheme for the target object, which assists the user in personalizing the health management of the target object.

It should be understood that a same user may feed a plurality of pets, and if the intelligent feeding device directly dispenses a corresponding amount of pet food during a feeding time period based on the target feeding scheme, a food-snatching behavior tends to occur among the plurality of pets, so the target object may not be able to eat based on the target feeding scheme, which affects the health of the target object. The following section of the present disclosure describes how to set up to avoid the food-snatching behavior among a plurality of pets.

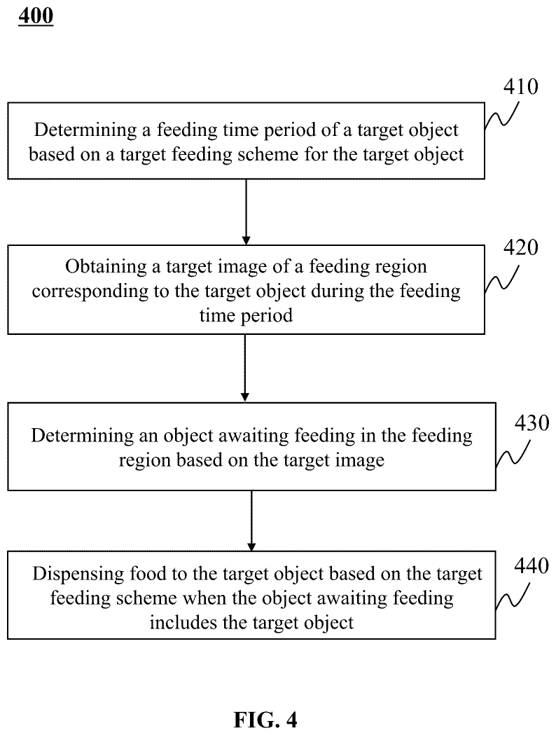

In some embodiments, the processor dispenses food targeting the target object through a process 400 as shown in FIG. 4, thereby avoiding the food-snatching behavior among a plurality of pets.

FIG. 4 is a flowchart illustrating a process of an intelligent feeding method according to some embodiments of the present disclosure. In some embodiments, a process 400 may be performed by a processor of an intelligent feeding device (e.g., the processor 150 of the intelligent feeding device 200 shown in FIG. 2). As shown in FIG. 4, the process 400 may include following steps.

Step 410, determining a feeding time period of a target object based on a target feeding scheme for the target object.

Step 420, obtaining a target image of a feeding region corresponding to the target object during the feeding time period.

The feeding region corresponding to the target object refers to a region where the target object is fed during the feeding time period. A feeding region of each target object may be the same or different.

The feeding region corresponding to the target object may be determined in various ways. For example, a user obtains an image region of a region in which a feeder is located through a user terminal (e.g., the user terminal 130 shown in FIG. 1), and marks the feeding region corresponding to the target object in the image region. As another example, the processor assigns a feeding port of the feeder to the target object, obtains the region image of the region in which the feeder is located, and determines a region in a preset range of the feeding port based on the region image and the feeding port corresponding to the target object as the feeding region of the target object.

The target image refers to an image that includes the feeding region corresponding to the target object during the feeding time period, and the target image is obtained before dispensing food. An image acquisition device (e.g., the image acquisition device 160 shown in FIG. 1) may obtain the target image by acquiring an image of the feeding region corresponding to the target object during the feeding time period, and the processor may obtain the target image from the image acquisition device.

Step 430, determining an object awaiting feeding in the feeding region based on the target image.

The object awaiting feeding refers to a feeding object that is located in the feeding region corresponding to the target object during the feeding time period. The object awaiting feeding may or may not include the target object.

The target image may include one or more objects awaiting feeding and may not include the object awaiting feeding. When the target image does not include the object awaiting feeding, the processor may continue obtaining the target image until a target image includes the object awaiting feeding is obtained.

In some embodiments, the processor performs modeling or employs various data analysis algorithms, such as regression analysis, discriminant analysis, or the like, to analyze and process the target image to determine the object awaiting feeding in the feeding region.

In some embodiments, the processor performs image recognition on the target image to determine feature information of the object awaiting feeding in a variety of manners.

The feature information refers to information that reflects the individual variability of the object awaiting feeding. In some embodiments, the feature information includes one or more of a breed feature, a body size feature, and a pattern feature of the object awaiting feeding. The breed feature refers to a feature that characterizes the breed of the object awaiting feeding. For example, when the target object is a Siamese cat, the breed feature includes the focus of color on the face. As another example, when the target object is a hairless cat, the breed feature includes the skin that is not covered by fur. The body size feature refers to a feature characterizing a body size of the object awaiting feeding. The body size feature may characterize at least one of a height, a length, width, etc., of the object awaiting feeding. The pattern feature characterizes a pattern of the object awaiting feeding. In some embodiments, the feature information further includes an additional feature of the object awaiting feeding. The additional feature refers to a feature that is additionally added to the object awaiting feeding. For example, the additional feature includes the color, pattern, or other features of accessories worn by the target object, such as a collar or foreign objects. It is worth stating that when there are a plurality of feeding objects with similar breed features, body size features, and pattern features, the user may add different additional features to similar feeding objects for the processor to recognize. For example, when the user includes two black cats of similar body sizes, the user may wear different colored collars for the two black cats, and the processor may determine an additional feature of the two black cats, i.e., the color of the collars, so as to differentiate between the two black cats. In some embodiments of the present disclosure, adding the additional feature to a similar feeding object can improve the correctness of the recognition of the processor, which guarantees the smooth implementation of the intelligent feeding method.

For example, the processor analyzes and processes the target image by an image recognition algorithm to determine the feature information of the object awaiting feeding.

In some embodiments, the processor further performs image recognition on the target image using a feature extraction model to determine the feature information of the object awaiting feeding. The feature extraction model may be one or a combination of a convolutional neural network, a deep learning model, or any other machine learning model that can be implemented to perform its function. An input of the feature extraction model is the target image, and an output of the feature extraction model is feature information of each object awaiting feeding. The feature extraction model may be obtained by training a plurality of sets of third training samples with a third label. The third training sample may include a sample image of a sample object, and the third label may be feature information of the sample object. The third training sample may be obtained by capturing a picture of the sample object, and the third label may be obtained by manually labeling the sample image.

In some embodiments, the processor determines the object awaiting feeding in the feeding region based on the feature information. The processor may obtain feature information of each feeding object. For example, the user uploads an image of each feeding object through the user terminal, and the processor performs image recognition on the image using the feature extraction model to determine the feature information of each feeding object. The processor may determine the object awaiting feeding by comparing the feature information of each feeding object and the feature information of the object awaiting feeding in a variety of manners (e.g., based on a vector distance or using a machine learning model).

For example, the processor determines that the target image includes feature information of two objects awaiting feeding, generates two third feature vectors based on the feature information of the two objects awaiting feeding, respectively, and generates a plurality of fourth feature vectors based on the feature information of each feeding object. For each of the third feature vectors, the processor may determine a vector distance between the third feature vector and each of the plurality of fourth feature vectors, and then determine a feeding object corresponding to a fourth feature vector with the smallest vector distance to the third feature vector as the feeding object awaiting feeding.

Step 440, when the object awaiting feeding includes the target object, dispensing food to the target object based on the target feeding scheme.

In some embodiments, after determining that the object awaiting feeding includes the target object, the processor determines a food-dispensing amount to the target object during the feeding time period based on the target feeding scheme, and controls the feeder to dispense a corresponding weight of pet food.

In some embodiments, after determining that the object awaiting feeding includes the target object, the processor further determines whether there are objects other than the target object, and when the object awaiting feeding includes and only includes the target object, the processor determines a food-dispensing amount during a feeding time period based on a feeding scheme, and controls the feeder to dispense a corresponding weight of pet food.

When the object awaiting feeding does not include the target object, the processor may continue to obtain a target image until the target object is recognized.

In some embodiments of the present disclosure, by recognizing the object awaiting feeding during a feeding time period, food can be automatically dispensed to the target object, which facilitates the user's pet feeding and enhances the user experience.

In some embodiments, a reminder light and/or a reminder audio is also arranged to avoid food-snatching behavior among a plurality of pets.

In some embodiments, when food is dispensed to the target object based on the target feeding scheme and the object awaiting feeding includes the target object, the processor controls an audio player to play a reminder audio corresponding to the target object. The reminder audio refers to an audio that reminds the target object to eat. The reminder audio corresponding to the target object may be preset, for example, the user sets different reminder audios for different target objects during different feeding time periods through the user terminal.

In some embodiments, the processor further controls a lighting apparatus to turn on a reminder light corresponding to the target object when dispensing food to the target object based on the target feeding scheme and the object awaiting feeding includes the target object. The reminder light refers to a light that reminds the target object to eat. The reminder light corresponding to the target object may be preset, for example, the user sets different color reminder lights for different target objects during different feeding time periods through the user terminal. Additionally, when the lighting in the feeding region is insufficient (e.g., at night or on cloudy days), the processor can control the lighting apparatus to illuminate the feeding region, so that the image acquisition device can capture target images with more feature information, thereby improving the accuracy of the processor in recognizing feeding objects in the feeding region.

In some embodiments of the present disclosure, by setting different corresponding reminder lights and/or reminder audios for different feeding objects, target objects during different feeding time periods can be targeted and reminded to eat, helping to cultivate pets' feeding habits at designated times and thus preventing food-snatching behavior between the plurality of pets.

In some embodiments, when the object awaiting feeding does not include the target object during the feeding time period corresponding to the target feeding scheme, the processor controls the audio player to play the reminder audio corresponding to the target object and/or control the lighting apparatus to turn on the reminder light corresponding to the target object to remind the target object. After the playback of the reminder audio and/or the reminder light is complete, the processor may obtain the target image to determine whether the target object is in the feeding region. In response to determining that the target object is not in the feeding region, the processor may again control the audio player to play the reminder audio corresponding to the target object and/or control the lighting apparatus to turn on the reminder light corresponding to the target object to obtain the target image for judgment until the target object is detected to be in the feeding region or a count of times that the reminder audio is played exceeds a preset reminder count threshold (e.g., 3 times). When the count of times that the reminder audio is played exceeds the preset reminder count threshold, the processor may delay a feeding time period corresponding to a feeding scheme of the target object, and a delay time may be preset. For example, the delay time is 1 hour. In some embodiments, for each feeding scheme of the target object, when a count of times a feeding time period in the feeding scheme is delayed exceeds a preset delay count threshold, the processor determines an actual feeding time period of the target object in the feeding scheme from historical feeding data and adjusts a feeding time period in the target feeding scheme based on an actual feeding time period. For example, when historical feeding data of a target object shows that a count of times the feeding time period is delayed exceeds the preset delay count threshold of 5 times, the processor determines actual feeding time periods of the target object of the last 5 delays from the historical feeding data. Various modeling or data analysis algorithms, such as regression analysis, discriminant analysis, etc., can be applied to analyze and process the actual feeding time periods of the last 5 delays to determine the feeding time period in the target feeding scheme.

In some embodiments, the food-snatching behavior among the plurality of pets may also be avoided in other ways. For example, feeding time periods of a plurality of feeding objects are staggered to avoid direct competition resulting from overlapping feeding time periods. As another example, when the feeding time periods of the plurality of feeding objects overlap, the processor controls the intelligent feeding device to adjust a food-dispensing speed to accommodate feeding objects with different food amounts and feeding speeds to ensure that they can complete feeding in a similar time frame. When a feeding of a feeding object with a slower feeding speed is not yet completed, the processor may delay dispensing pet food to a feeding object with a faster feeding speed, preventing the feeding object with the faster feeding speed from moving to feeding regions of other feeding objects to snatch food. As another example, a plurality of feeding objects are assigned separate feeding regions. As another example, a water spraying device is provided on the intelligent feeding device to force pets who snatch food to leave when the food-snatching behavior occurs. As another example, a blocking device is provided on the intelligent feeding device to ensure that the feeding region can only accommodate the target object, thereby avoiding the food-snatching behavior.

Through one or more of the foregoing embodiments, the intelligent feeding device can avoid the food-snatching behavior among the plurality of pets, and prevent the target object from being interfered with by other pets while being fed based on the target feeding scheme, which may interrupt the target object's feeding and affect the health management of the target object. At the same time, health issues caused by other feeding objects feeding outside of their corresponding feeding schemes can be avoided.

During a feeding process, if a pet feeds too quickly, it may cause issues such as vomiting, indigestion, and other problems, which can negatively affect the pet's health. Existing solutions for slowing down feeding of a pet include the use of a specially-designed slow-feeding bowl, a feeder with a switch, a turntable-style apparatus, or the like. The slow-feeding bowl typically has uneven internal surfaces or built-in obstacles to slow down the pet's feeding speed. The slow-feeding bowl is difficult to clean due to its special design, which makes it prone to harboring dirt and grime, affecting hygiene and making it uncomfortable for pets to use. The feeder with a switch or the turntable-style apparatus has a complex structure, and there is also the danger that pets may be caught in the switching process.

The following section of the present disclosure will explain how to set up measures to prevent pets from feeding too quickly.

In some embodiments, the processor prevents the pet from feeding too quickly by controlling a food-dispensing speed in a feeding scheme.

In some embodiments, when dispensing food to the target object, the processor further obtains a weight of pet food in a food bowl, and after the weight of the pet food in the food bowl is less than a preset weight threshold (e.g., 5 g), the process continues to dispense food to avoid an excessive accumulation of the pet food in the food bowl, and thus an amount of pet food at each time can be controlled to prevent the pet from feeding too quickly.

In some embodiments, the feeding scheme further includes a plurality of sub-feeding schemes for stages. For example, the target feeding scheme and/or the current feeding scheme includes a plurality of sub-feeding schemes for stages. A sub-feeding scheme for each stage may include a sub-feeding time period and a sub-food-dispensing amount. For a sub-feeding scheme for each stage, the sub-feeding time period may be a feeding time of the target object at the stage, and the sub-food-dispensing amount may be a weight of food dispensed to the target object at the stage. For example, a feeding scheme includes sub-feeding schemes for three stages, where a sub-feeding scheme for a first stage includes a sub-feeding time period of 08:00 to 08:10 and a sub-food-dispensing amount of 5 g, a sub-feeding scheme for a second stage includes a sub-feeding time period of 08:10 to 08:20 and a sub-food-dispensing amount of 5 g, and a sub-feeding scheme for a third stage includes a sub-feeding time period of 08:20 to 08:30 and a sub-food-dispensing amount of 5 g.

The processor may obtain the plurality of sub-feeding schemes for stages in a variety of ways. For example, the processor obtains a plurality of sub-feeding schemes for stages corresponding to a target feeding scheme by segmenting the target feeding scheme according to a preset segmentation rule. As another example, the processor further analyzes and processes the current feeding information of the target object to determine a segmentation manner of the target feeding scheme, and segments the target feeding scheme based on the segmentation manner to obtain the plurality of sub-feeding schemes for stages corresponding to the target feeding scheme. As another example, the output of the target feeding model includes the target feeding scheme that includes the plurality of sub-feeding schemes for stages.

In some embodiments, the processor controls the intelligent feeding device to dispense food to the target object stage-by-stage based on the plurality of sub-feeding schemes for stages. For a sub-feeding scheme for each stage, the processor may control the feeder to dispense food corresponding to the sub-food-dispensing amount during the sub-feeding time period of the sub-feeding scheme until the food dispensing of the sub-feeding scheme for each stage is completed. Based on the setup, the feeding speed of the pet can be controlled to avoid health problems caused by feeding too quickly, which facilitates cleaning and eliminates the need to purchase additional tools, thereby reducing the cost of pet feeding.

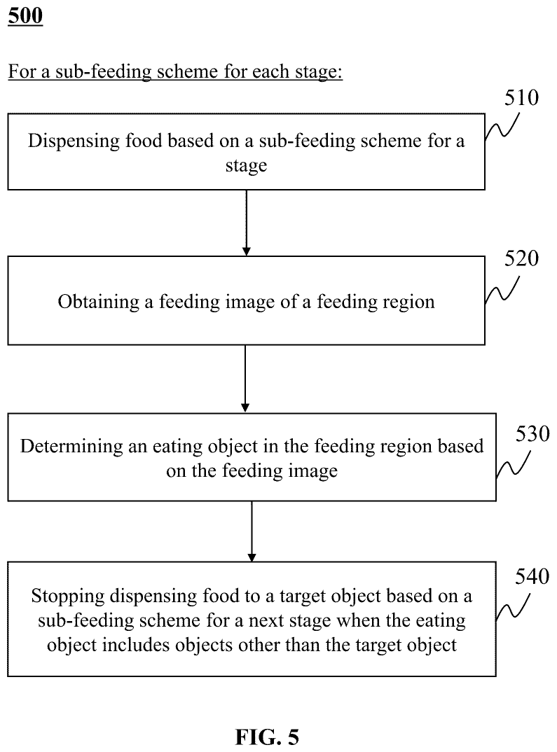

In some embodiments, for a sub-feeding scheme for each stage, after dispensing food to the target object based on the sub-feeding scheme, the processor further determines whether there is a food-snatching behavior and determines whether to continue to dispense food for a next stage. More about the above embodiment can be found in FIG. 5 and the related description thereof.

FIG. 5 is a flowchart illustrating a multi-stage intelligent feeding method according to some embodiments of the present disclosure. In some embodiments, a process 500 may be performed by a processor of an intelligent feeding device (e.g., the processor 150 of the intelligent feeding device 200 shown in FIG. 2). As shown in FIG. 5, for a feeding scheme for each stage, the processor may execute the process 500 to determine whether to proceed to dispense food for a next stage, and the process 500 may include following steps: Step 510, dispensing food based on a sub-feeding scheme for a stage.

The processor may control a feeder to dispense a corresponding weight of pet food during a corresponding time period based on a sub-feeding time period and a sub-food-dispensing amount in the sub-feeding scheme for the stage.

Step 520, obtaining a feeding image of a feeding region.

The feeding image refers to an image of a feeding region corresponding to a target object after the pet food is dispensed based on the sub-feeding scheme for the stage. Similar to the target image, after the processor controls the feeder to dispense food based on the sub-feeding scheme for the stage, an image acquisition device may obtain the feeding image by capturing an image of the feeding region corresponding to the target object, and then the processor may obtain the feeding image from the image acquisition device.

Step 530, determining an eating object in the feeding region based on the feeding image.

The eating object refers to a feeding object in the feeding region corresponding to the target object after the pet food has been dispensed based on the sub-feeding scheme for the stage. The eating object may be fed, and the eating object may not be fed but merely be in the feeding region of the target object.

The processor may perform image recognition on the feeding image to determine the eating object in the feeding region. For example, the processor processes the feeding image using a feature extraction model to determine feature information of the eating object, and determines the eating object based on the feature information of the eating object. More about the feature extraction model and the feature information can be found in FIG. 4 and the related description thereof.

Step 540, stopping dispensing food to the target object based on a sub-feeding scheme for a next stage when the eating object includes objects other than the target object.

It is worth stating that feeding time periods in feeding schemes of a plurality of target objects may overlap, but feeding regions of the plurality of target objects at the same time point do not overlap to guarantee the normal operation of the intelligent feeding method in the embodiments of the present disclosure.

When the eating object does not include objects other than the target object, the processor may continue to control the feeder to dispense food to the target object based on the sub-feeding scheme for the next stage. When the eating object includes objects other than the target object, the processor may control the feeder to stop dispensing food to the target object based on the sub-feeding scheme for the next stage.

When the eating object includes objects other than the target object, the processor may also continue to obtain eating objects in the feeding region, and when the processor recognizes that the eating object in the feeding region includes and only includes the target object, the processor may continue to control the feeder to dispense food to the target object based on the sub-feeding scheme for the next stage.

In some embodiments, a reminder audio and/or reminder light is played to entice the target object to return to the feeding region when the processor recognizes that the eating object in the feeding region does not include the target object. More about the reminder audio can be found in the relevant description above in the present disclosure.

In some embodiments of the present disclosure, recognizing the eating object in the feeding region to determine whether to continue to dispense food can effectively prevent objects other than the target object from snatching food, which allows for precise control of each target's food intake, helping to avoid obesity and ensuring the pet's health.

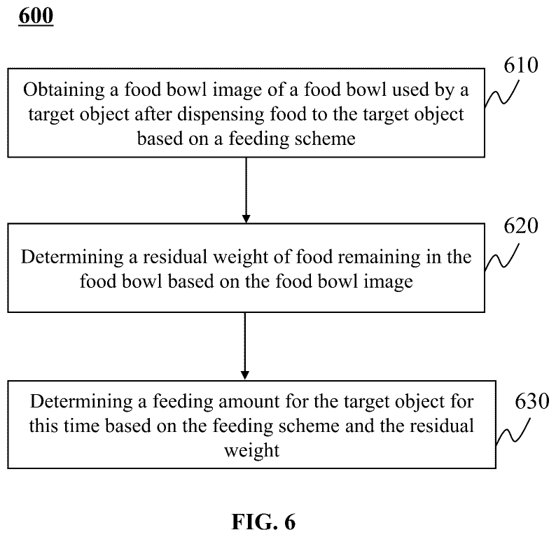

FIG. 6 is a flowchart illustrating a process for determining a feeding amount of a target object according to some embodiments of the present disclosure. In some embodiments, a process 600 may be performed by a processor of an intelligent feeding device (e.g., the processor 150 of the intelligent feeding device 200 shown in FIG. 2). As shown in FIG. 6, the process 600 may include following steps:

Step 610, obtaining a food bowl image of a food bowl used by a target object after the processor has finished dispensing food to the target object based on a feeding scheme.

The food bowl image refers to an image of a food bowl used by a target object after dispensing food the target object is finished based on a feeding scheme (e.g., a current feeding scheme, a target feeding scheme, etc.). Similar to the target image, after the processor controls the feeder to dispense food to the target object based on the feeding scheme (e.g. after a feeding time period in the feeding scheme has ended), an image acquisition device may capture an image of the food bowl used by the target object in a feeding region corresponding to the target object to obtain the food bowl image, and then the processor may obtain the food bowl image from the image acquisition device.

Step 620, determining a residual weight of food remaining in the food bowl based on the food bowl image.

In some embodiments, the processor analyzes and processes the food bowl image in a variety of manners (e.g., modeling or various types of data analysis algorithms) to determine the residual weight of food remaining in the food bowl.

For example, the processor inputs the food bowl image into a weight analysis model, and the output of the weight analysis model is the residual weight of the food remaining in the food bowl. The weight analysis model may be one or more of a convolutional neural network model, a deep learning model, or any other machine learning model that implements its functionality. The weight analysis model may be obtained by training a plurality of sets of fourth training samples with a fourth label. The fourth training sample may include a sample food bowl image, and the fourth label may include a residual weight of food remaining in the food bowl in the sample food bowl image. The fourth training sample may be obtained by capturing an image, and the fourth label may be obtained by measuring a residual weight of the food remaining in the food bowl in the sample food bowl image. In some embodiments, the input to the weight analysis model may also include other information. For example, the input to the weight analysis model may also include at least one of a type, brand, etc. of the pet food, which can be obtained through user input. Correspondingly, when training the weight analysis model, the fourth training sample may also include at least one of a type, brand, etc. of the sample pet food. By inputting at least one of the type, brand, etc., of the pet food into the weight analysis model, the accuracy of the output result of the weight analysis model can be safeguarded, and errors due to the variability of the pet food of different types and brands (e.g., different water content) can be avoided.

Step 630, determining a feeding amount for the target object for this time based on the feeding scheme and the residual weight.

The processor may determine a food-dispensing amount in a feeding scheme for this time based on the feeding scheme and calculate a difference between the food-dispensing amount and the residual weight of food remaining, and the difference is the feeding amount for the target object based on the feeding scheme for this time.

In some embodiments of the present disclosure, by monitoring the residual weight of the food remaining in the food bowl, it is possible to understand a feeding amount for the target object each time, which facilitates the user to keep track of the feeding situation of the target object, and to understand the growth information of the feeding object.

It should be noted that the foregoing descriptions with respect to the various processes are for the purpose of exemplification and illustration only and do not limit the scope of application of the present disclosure. For a person skilled in the art, various corrections and changes can be made to the individual processes under the guidance of the present disclosure. However, these corrections and changes remain within the scope of the present disclosure.

Some embodiments of the present disclosure further provide an intelligent feeding system, comprising at least one storage device including a set of instructions and at least one processor in communication with the at least one storage device. When executing the set of instructions, the at least one processor is configured to cause the system to perform operations comprising: obtaining a current feeding scheme of a target object, dispensing food to the target object based on the current feeding scheme, and obtaining current feeding information of the target object when dispensing food to the target object based on the current feeding scheme; and determining a target feeding scheme for the target object based on the current feeding information, historical feeding data, and the current feeding scheme, and dispensing food to the target object based on the target feeding scheme.

Some embodiments of the present disclosure further provide a computer non-transitory readable storage medium storing computer instructions. When the computer reads the computer instructions in the non-transitory readable storage medium, an intelligent feeding method is executed, comprising following operations: obtaining a current feeding scheme of a target object, dispensing food to a target object based on the current feeding scheme, and obtaining current feeding information of the target object when dispensing food to the target object based on the current feeding scheme; and determining a target feeding scheme for the target object based on the current feeding information, historical feeding data, and the current feeding scheme, and dispensing food to the target object based on the target feeding scheme.

The basic concepts have been described above, and it is apparent to those skilled in the art that the foregoing detailed disclosure serves only as an example and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure. Such as “an embodiment”, “one embodiment”, and/or “some embodiments” means a feature, structure, or characteristic associated with at least one embodiment of the present disclosure. Accordingly, it should be emphasized and noted that “an embodiment” or “one embodiment” or “an alternative embodiment” in different places in the present disclosure do not necessarily refer to the same embodiment. In addition, certain features, structures, or characteristics of one or more embodiments of the present disclosure may be suitably combined.

Additionally, unless expressly stated in the claims, the order of the processing elements and sequences, the use of numerical letters, or the use of other names as described in the present disclosure are not intended to qualify the order of the processes and methods of the present disclosure. While some embodiments of the invention that are currently considered useful are discussed in the foregoing disclosure by way of various examples, it is to be understood that such details serve only illustrative purposes, and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software-only solution, e.g., an installation on an existing server or mobile device.

Similarly, it should be noted that in order to simplify the presentation of the disclosure of the present disclosure, and thereby aid in the understanding of one or more embodiments of the invention, the foregoing descriptions of embodiments of the present disclosure sometimes combine a variety of features into a single embodiment, accompanying drawings, or descriptions thereof. However, this method of disclosure does not imply that more features are required for the objects of the present disclosure than are mentioned in the claims. Rather, claimed subject matter may lie in less than all features of a single foregoing disclosed embodiment.

Some embodiments use numbers to describe the number of components, attributes, and it should be understood that such numbers used in the description of embodiments are modified in some examples by the modifiers “approximately”, “nearly”, or “substantially”. Unless otherwise noted, the terms “approximately”, “nearly”, or “substantially” indicates that a +20% variation in the stated number is allowed. Correspondingly, in some embodiments, the numerical parameters used in the present disclosure and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments, such values are set to be as precise as possible within a feasible range.

For each of the patents, patent applications, patent application disclosures, and other materials cited in the present disclosure, such as articles, books, specification sheets, publications, documents, or the like, are hereby incorporated by reference in their entirety into the present disclosure. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those set forth herein, the descriptions, definitions, and/or use of terms in the present disclosure shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. An intelligent feeding method, comprising:
obtaining a current feeding scheme of a target object, dispensing food to the target object based on the current feeding scheme, and obtaining current feeding information of the target object when dispensing food to the target object based on the current feeding scheme; and
determining a target feeding scheme for the target object based on the current feeding information, historical feeding data, and the current feeding scheme, and dispensing food to the target object based on the target feeding scheme.

2. The method of claim 1, wherein the obtaining the current feeding scheme of the target object includes:
determining the current feeding scheme of the target object based on first object information of the target object and an initial feeding scheme using a same-type feeding model.

3. The method of claim 1, wherein the determining the target feeding scheme for the target object based on the current feeding information, the historical feeding data, and the current feeding scheme includes:
obtaining a feeding target of the target object; and
determining the target feeding scheme for the target object based on the feeding target, the current feeding information, the historical feeding data, and the current feeding scheme.

4. The method of claim 3, wherein the determining the target feeding scheme for the target object based on the feeding target, the current feeding information, the historical feeding data, and the current feeding scheme includes:
determining the target feeding scheme for the target object by adjusting the current feeding scheme through a scheme adjustment strategy based on the feeding target, the current feeding information, and the historical feeding data.

5. The method of claim 3, wherein the determining the target feeding scheme for the target object based on the feeding target, the current feeding information, the historical feeding data, and the current feeding scheme includes:
obtaining a target feeding model of the target object based on first object information of the target object, the current feeding information, the historical feeding data, and the current feeding scheme; and
determining the target feeding scheme for the target object based on second object information of the target object, the current feeding scheme, and the feeding target using the target feeding model.

6. The method of claim 3, wherein the feeding target includes at least one of a target glycemic stability, a target weight change value, or a target calorie intake of the target object.

7. The method of claim 1, further comprising:
determining a feeding time period of the target object based on the target feeding scheme;
obtaining a target image of a feeding region corresponding to the target object during the feeding time period;
determining an object awaiting feeding in the feeding region based on the target image; and
in response to determining the object awaiting feeding including the target object, dispensing food to the target object based on the target feeding scheme.

8. The method of claim 1, further comprising:
when dispensing food to the target object based on the target feeding scheme, playing a reminder audio corresponding to the target object and/or turning on a reminder light corresponding to the target object.

9. The method of claim 1, wherein the target feeding scheme includes a plurality of sub-feeding schemes for stages,
dispensing food to the target object based on the target feeding scheme includes:
dispensing food to the target object stage by stage based on the plurality of sub-feeding schemes for stages.

10. The method of claim 9, wherein the dispensing food to the target object stage by stage based on the plurality of sub-feeding schemes for stages includes:
for a sub-feeding scheme for each stage;
dispensing food based on the sub-feeding scheme for each stage;
obtaining a feeding image of a feeding region;
determining an eating object in the feeding region based on the feeding image; and
stopping dispensing food to the target object based on a sub-feeding scheme for next stage when the eating object includes objects other than the target object.

11. An intelligent feeding device, comprising a processor and a feeder, wherein
the feeder is configured to store and dispense pet food; and
the processor is configured to:
obtain a current feeding scheme of a target object, dispense food to the target object based on the current feeding scheme, and obtain current feeding information of the target object when dispensing food to the target object based on the current feeding scheme; and
determine a target feeding scheme for the target object based on the current feeding information, historical feeding data, and the current feeding scheme, and dispense food to the target object based on the target feeding scheme.

12. The device of claim 11, wherein the processor is further configured to:
determine the current feeding scheme of the target object based on first object information of the target object and an initial feeding scheme using a same-type feeding model.

13. The device of claim 11, wherein the processor is further configured to:
obtain a feeding target of the target object; and
determine the target feeding scheme for the target object based on the feeding target, the current feeding information, the historical feeding data, and the current feeding scheme.

14. The device of claim 13, wherein the determining the target feeding scheme for the target object based on the feeding target, the current feeding information, the historical feeding data, and the current feeding scheme includes:
determining the target feeding scheme for the target object by adjusting the current feeding scheme through a scheme adjustment strategy based on the feeding target, the current feeding information, and the historical feeding data.

15. The device of claim 13, wherein the processor is further configured to:
obtain a target feeding model of the target object based on first object information of the target object, the current feeding information, the historical feeding data, and the current feeding scheme; and
determine the target feeding scheme for the target object based on second object information of the target object, the current feeding scheme, and the feeding target using the target feeding model.

16. The device of claim 13, wherein the feeding target includes at least one of a target glycemic stability, a target weight change value, or a target calorie intake of the target object.

17. The device of claim 11, wherein the processor is further configured to:
determine a feeding time period of the target object based on the target feeding scheme;
obtain a target image of a feeding region corresponding to the target object during the feeding time period;
determine an object awaiting feeding in the feeding region based on the target image; and
in response to determining the object awaiting feeding including the target object, dispense food to the target object based on the target feeding scheme.

18. The device of claim 11, wherein the device further includes an audio player and/or a lighting apparatus,
the audio player is configured to:
play a reminder audio corresponding to the target object when dispensing food to the target object based on the target feeding scheme; and
the lighting apparatus is configured to:
turn on a reminder light corresponding to the target object when dispensing food to the target object based on the target feeding scheme.

19. The device of claim 11, wherein the target feeding scheme includes a plurality of sub-feeding schemes for stages, and the processor is further configured to:
dispense food to the target object stage by stage based on the plurality of sub-feeding schemes for stages.

20. The device of claim 19, wherein the processor is further configured to:
for a sub-feeding scheme for each stage;
dispense food based on the sub-feeding scheme for each stage;
obtain a feeding image of a feeding region;
determine an eating object in the feeding region based on the feeding image; and
stop dispensing food to the target object based on a sub-feeding scheme for next stage when the eating object includes objects other than the target object.
